(19) United States
(12) Patent Application Publication
(10) Pub. No.: US 2022/0142872 A1
(43) Pub. Date: May 12, 2022

(54) Silicone Protector for a Drinking Vessel

(71) Applicant: Enis Ayari, Kiel (DE)

(72) Inventor: Enis Ayari, Kiel (DE)

(21) Appl. No.: 17/438,417

(22) PCT Filed: Mar. 18, 2020
(86) PCT No.: PCT/DE2020/100213

§ 371 Date: Sep. 11, 2021

(30) Foreign Application Priority Data
Mar. 26, 2019 (DE) 202019101731.7

(51) Int. Cl. A61J 9/08; A61J 9/06; B65D 23/00

(52) U.S. Cl. CPC A61J 9/08; A61J 9/0684; B65D 2203/12; A61J 2205/20; A61J 2205/50; B65D 23/001

(57) ABSTRACT

The invention relates to a silicone protector (1) for a drinking vessel (7), the silicone protector (1) having an all-around lateral part (3) with a top opening (1.1) for a part of the drinking vessel (7) extending upwards from the top opening (1.1) and a base part (3.2). According to the invention, the silicone protector (1) comprises an LED module (2) and the LED module (2) is in the form of a disk and is inserted in the silicone protector (1) on top of the base part (3.2).

### CROSS REFERENCE TO RELATED APPLICATIONS

This application is the U.S. national stage of International Application No. PCT/DE2020/100213, filed on 2020 Mar. 18. The international application claims the priority of DE 202019101731.7 filed on 2019 Mar. 26; all applications are incorporated by reference herein in their entirety.

### BACKGROUND

The invention relates to a silicone protector for a drinking vessel, in particular for babies and toddlers, according to the preamble of the first claim.

The prior art is a US patent application U.S. Pat. No. 5,662,406A from 1996, comprising a fixed illuminating unit on the bottom of a baby bottle. A two-part housing is provided for this purpose. The two housing parts can be screwed together. The illuminating element, the light source, the main switch and the power supply are connected to the underside of a cover of the first housing part, which is connected to the bottle part, and are thus located in the second housing part, which is arranged at the end, and are covered by it. The illuminating element, the light source, the main switch and the power supply are not designed as a structural unit and cannot be removed as a unit from the housing. Furthermore, the housing can only be attached to a certain type of bottle by way of shaped elements.

There is also a product on the US market, a product from heaven lyhalobabybottleaccessories, which can be fastened around bottles by Velcro and which then illuminates the bottle.

US 2007/0193908 A1 discloses a drinking bottle with a protector which has illuminating elements, wherein the protector has a circumferential edge region with a top opening for a region of the drinking bottle that protrudes out of the opening. In this solution, a sleeve is wrapped around the baby bottle. This sleeve may have illuminating elements.

CN 109350535 A discloses an illuminating baby bottle, by which music can also be played. The illuminating effect is achieved by an illuminating strip which is mounted on the circumference.

A baby bottle with illuminating strips on the side is described in U.S. Ser. No. 10/004,665 B2.

However, the self-illuminating elements (here strips) have a time-limited illuminating duration of usually only 5-6 hours.

It is not reliably ensured that the bottle, if it falls, will be protected against breakage.

Document US 2018/010785 A1 discloses a bottle holding apparatus having a removable LED light source, the apparatus holding a bottle in such a way that light illuminates a lower part of the bottle, as a result of which the apparatus provides visual lighting effects and is said to create a romantic atmosphere for drinking alcohol. To this end, an illuminating module is inserted from below into a cutout previously formed in the base. The production of this cutout means additional complexity of the device and additional manufacturing effort. The illuminating module is manufactured in a standard size so that it can be inserted in bottle holder bodies of different size. A bottle holder body must therefore be manufactured for each bottle size, which is also disadvantageous.

Also known are coasters made of glass, acrylic glass or metal, in which one or more LEDs are integrated. However, these are not suitable for safely holding a baby bottle or a drinking vessel for a baby or toddler.

Document EP 2 708 220 A2 discloses a baby bottle sleeve made of silicone. It comprises a cylindrical sleeve made of an elastomeric material for receiving a baby bottle, having a top opening for an upper end region of a baby bottle, which protrudes out of the sleeve, and a cutout extending downwards from the edge of the top opening, which cutout can be opened in order to insert and remove a baby bottle and has at least one closable and openable closure means which in the closed state fixes the cutout in the closed position and in the open state releases the cutout so that the latter can be opened. However, this sleeve is not illuminated.

DE 297 18 321 U1 discloses a soft feeding bottle sheath for liquid baby and toddler food. It is made for example of silicone, is designed in the form of a sleeve, and can be pulled separately onto the bottle. The sleeve may be open on one side and may serve as a cover.

The two aforementioned solutions have the disadvantage that no illumination is provided with these.

### SUMMARY

The object of the invention is to develop a silicone protector for a drinking vessel, such as a bottle, a glass, a mug or a cup, in particular for babies and toddlers, which is suitable for safely receiving the drinking vessel and can be retrofitted on almost any drinking vessel, in particular almost any baby and toddler bottle, and by which the drinking vessel can be made to light up or can be illuminated.

This object is achieved by the features of the first claim. Advantageous embodiments will emerge from the dependent claims.

### DETAILED DESCRIPTION

The silicone protector according to the invention for a drinking vessel has a circumferential edge region with a top opening for a region of the drinking vessel that protrudes out of the top opening, and has a base region, and is combined with an LED module, wherein the LED module is disc-shaped and is inserted or placed into the silicone protector above the base region, and wherein the edge region made of silicone is so elastic that it can be widened from an internal diameter that is smaller than the external diameter of the LED module and the external diameter of the drinking vessel to a diameter that makes it possible to receive the LED module and that is larger than the external diameter of the drinking vessel.

In the switched-on state, the LED module emits light onto the drinking vessel firmly seated therein, so that the position thereof can be reliably ascertained even in the dark.

The edge region is advantageously circumferentially closed and encircles the LED module.

The silicone protector is preferably provided with a base region which adjoins the edge region opposite the top opening, the edge region and/or the base region being detachably or non-detachably connected to the LED module.

The LED module is preferably provided with an on/off switch on its underside pointing in the direction of the base region, via which the LEDs can be switched on and off. It is also possible additionally to provide a twilight switch, via which the LEDs can be switched on when darkness starts to fall. Via an optional integrated timer, it is possible to select the duration of illumination of the LEDs (for example 4 hours, 6 hours, 8 hours).

Advantageously, the the base region has an opening in the region of the on/off switch, through which the switch can be actuated.

The edge region has a circumferential region which first in a first sub-region at the bottom is substantially cylindrical and has an internal diameter. This is adjoined in the upward direction by a second sub-region, which reduces from the internal diameter to an internal diameter in the region of the top opening.

The first sub-region is adjoined at the bottom by the base region. The first sub-region at least partially encloses the LED module around the circumference, and the base region at least partially encloses the LED module on the underside.

Advantageously, the first sub-region is provided with an aperture in the region of a connection socket of the LED module in order to ensure that the batteries of the LED module can be charged.

The LED module has at least one illuminating element, in particular an LED, on its circumference and/or on its upper side pointing in the direction of the top opening, wherein the LED module is transparent at least in the region of the illuminating element(s) in order to ensure that the light emitted by the LEDs also exits from the LED module.

The solution according to the invention provides a simple possibility for illuminating a drinking vessel, wherein the silicone protector designed for this remains on the drinking vessel when the drinking vessel is picked up by a person.

The invention will be explained in greater detail below with reference to drawings.

### BRIEF DESCRIPTION OF THE DRAWINGS

In the drawings:

FIG. 1 shows a silicone protector for receiving a baby bottle, comprising an LED module and an edge region in which the baby bottle can be fastened with a force fit,

FIG. 2 shows the view of the LED module from above with the logo “bumpli”,

FIG. 3 shows the LED module in a 3D view from below with the on/off switch as well as the input for the micro USB charging input,

FIG. 4 shows the LED module with the edge region detachably connected thereto,

FIG. 5 shows the LED module firmly seated in the edge region and, above it, the lower circumferential region of a bottle, for example a baby bottle,

FIG. 6 shows a three-dimensional sectional view of the edge region.

### DETAILED DESCRIPTION OF THE PREFERRED EMBODIMENTS

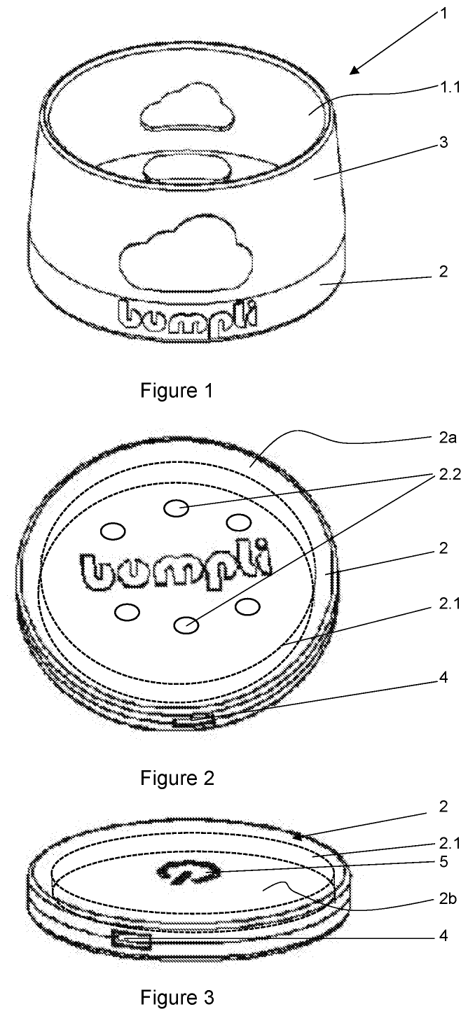

FIG. 1 shows a universal silicone protector 1 which has an LED module 2 and an edge region 3. The LED module 2 is connected, in particular firmly but detachably, to the edge region 3 made of silicone since it clamps with its external diameter in the elastic edge region 3.

Alternatively, the LED module 2 and the edge region 3 may also be non-detachably connected to one another.

The separate illustration of the LED module 2 is shown from the direction of its upper side 2a in FIG. 2 and from the direction of the underside 2b in FIG. 3. The LED module has a disc-shaped housing, which is not designated separately. A logo—in this case “bumpli”—is optionally located on the upper side 2a, and multiple LEDs 2.2 are integrated in the LED module 2, these being merely indicated here. The upper side 2a is transparent or open at least in the region of the LEDs 2.2 so that the light from the LEDs shines out from the LED module in the switched-on state. The on/off switch 5 for the LEDs 2.2 is provided on the underside 2b.

A connection socket 4, for example in the form of a micro USB charging input for charging the battery (not shown), is provided in the side region.

According to one variant (not shown), multiple LEDs or an LED strip may also be arranged on the circumferential region of the LED module 2.

Integrated in the LED module 2 is at least one electronics assembly 2.1, which is indicated by dashed lines in FIGS. 2 and 3 and includes at least one or else multiple LEDs 2.2 that can be switched on and off via the switch 5, which is preferably located on the underside 2b. At least one rechargeable battery (not shown), to which the LEDs 2.2 are connected, is integrated in the electronics assembly 2.1 in the LED module 2. A connection socket 4 for charging the battery is provided in the side of the LED module 2.

The LED module 2 is preferably designed in the form of a housing and in the manner of a disc. The diameter of the LED module 2 is preferably 60 to 70 mm, particularly preferably 65 mm, and the height thereof is preferably 5 to 10 mm, particularly preferably 8 mm.

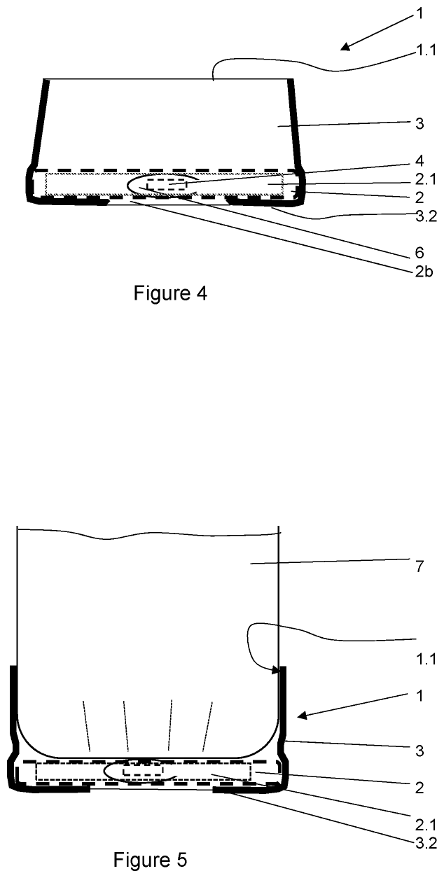

FIG. 4 shows a schematic diagram of the silicone protector 1 with the top opening 1.1, in which the edge region 3 is adjoined by a base region 3.2 that extends below the underside 2b of the LED module 2. In the edge region 3, a flap 6 is provided in the region of the connection socket 4 of the LED module 2, which flap can be opened in order to connect a charging cable (not shown) to the connection socket 4. Once the charging cable has been removed, the flap 6 can be closed again in a liquid-tight manner.

According to one exemplary embodiment, which is not shown, an aperture may also be provided in the edge region 3, instead of a flap, through which aperture the connection socket 4 can be accessed. It is then possible to provide a flap for closing the connection socket 4 directly on the LED module 2.

In FIG. 4, the electronics assembly 2.1 seated in the LED module 2 is indicated by a dotted line.

FIG. 5 shows the bottom end of a drinking vessel 7, here a baby bottle, which is firmly seated in the silicone protector 1.

Instead of a drinking vessel in the form of a baby bottle, a different type of drinking vessel, for example a different commercially available bottle, a glass, a mug or a cup, may be equipped with the silicone protector.

The drinking vessel 7, which is introduced with its lower region into the silicone protector 1, protrudes out of the top opening 1.1.

For this, the upward-pointing part of the edge region 3 and thus the top opening 1.1 of the silicone protector 1 has been elastically widened and pulled over the external diameter (bearing no reference sign) of the drinking vessel 7, as a result of which the drinking vessel 7 (in this case the baby bottle, but also a glass, a mug and the like) is firmly seated in the upwardly pointing edge region 3 once the latter has sprung back. The base (not shown) of the drinking vessel 7 then bears against the LED module 2 or is at only a slight distance therefrom. The silicone protector 1 is now firmly and captively connected to the drinking vessel 7.

When the LEDs situated in the LED module 2 are switched on, they emit light onto the drinking vessel 7 and the contents thereof. The LED module 2 is in this case likewise made of silicone or else of plastic and is translucent to the light of the one or multiple LEDs, at least on the side pointing upwards in the direction of the bottle and optionally also in the edge region.

Even if the drinking vessel is not translucent, light is emitted via the silicone protector, in particular via the edge region thereof.

As shown in FIGS. 4 and 5, the edge region 3 and the base region 3.2 are formed in one piece and are preferably firmly and captively connected to the LED module 2.

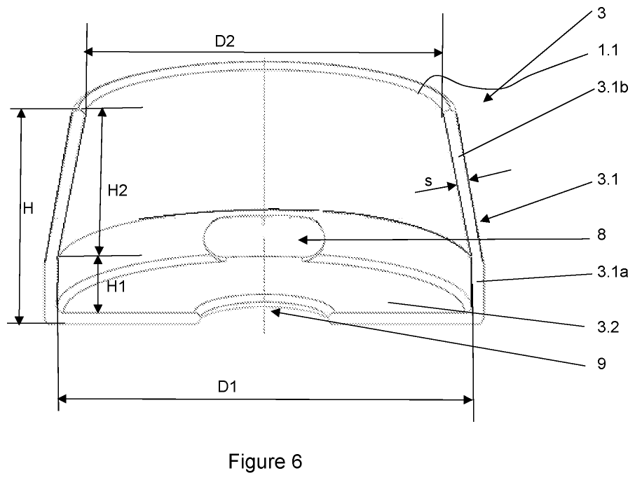

The edge region 3 is shown separately in FIG. 6. It has a circumferential region 3.1, which first in a first sub-region 3.1a is substantially cylindrical and has an internal diameter D1. An aperture 8 is provided in the first sub-region 3.1a. The second sub-region 3.1b, which adjoins the first sub-region 3.1a in the upward direction, reduces to an internal diameter D2.

The first sub-region 3.1a is adjoined at the bottom by the base region 3.2, which here has a central opening 9.

The internal diameter D1 of the first wall region 3.1a is preferably 60 to 70 mm, particularly preferably 65 mm, and corresponds to the external diameter of the LED module 2 (not shown here).

The height H1 of the sub-region 3.1a is likewise matched to the height of the LED module and is preferably 5 to 10 mm, particularly preferably 8 mm, starting from the base region 3.2.

The internal diameter D2 of the second sub-region 3.1b is preferably 53 to 60 mm, particularly preferably 56.00 mm, and the height H2 of the second sub-region 3.1b is preferably 20 to 30 mm, particularly preferably 25 mm.

The total height H is preferably between 25 and 50 mm.

The wall thickness s of the silicone edge region 3 and of the base region 3.2 is preferably 1 to 3 mm, particularly preferably 2 mm.

The LED module 2 is inserted from above, via the top opening 1.1 having the diameter D2, into the edge region 3 made of silicone, which is shown by way of example in FIG. 6, wherein said edge region can widen accordingly, and wherein the on/off switch of the disc-shaped LED module 2 points downwards and in the assembled/inserted state is located in the region of the opening 9 of the base region 3.2. The connection socket 4 of the LED module 2 is then located in the region of the aperture 8. The LED module 2 is thus almost completely enclosed around its circumference and on its underside by the silicone material of the wall region 3.

It is also possible that the edge region 3 is continuous in its base region 3.2 and the on/off switch of the LED module 2 can be actuated by pressing on the base region 3.2 located below the on/off switch.

Once the LED module 2 has been inserted into the edge region 3, the LED module 2 sits captively therein since the second sub-region 3.1b reduces in diameter in the upward direction.

The baby bottle, for example, can then be inserted into the edge region 3 until the bottle base bears against the LED module 2 or is at only a slight distance therefrom (see FIG. 5).

It is also possible to connect the edge region and the LED module to one another in a non-detachable manner, for example by welding or adhesive bonding.

The silicone protector 1 covers the bottom end of the drinking vessel 7 and illuminates when it is switched on.

The silicone protector 1 can remain on the drinking vessel 7 and can be rinsed with water or for example cleaned in the dishwasher along therewith if the LED module 2 is of waterproof design and the connection socket 4 is likewise closed in a watertight manner.

The silicone protector 1 according to the invention protects the drinking vessel if it falls since the drinking vessel hits first in this region due to the weight of the silicone protector 1 with the LED module 2. In addition, the LED module 2 gives off a pleasant light, which makes it possible to safely pick up the drinking vessel and put it back down again in the dark and provides an orientation aid.

Use is preferably made of transparent silicone so that the light emitted by the LEDs passes through the edge region and a decoration on the bottle, glass or other drinking vessel is still visible through the edge region.

It is the first universal “silicone bumper”, which due to the use of the integrated LED module fits almost any baby and toddler bottle base and thus turns the bottle into a night light. Universal use is possible for the simple reason that more than 90% of the baby and toddler bottles on the market have a base diameter of approximately 60-75 mm.

Universal use is thus possible due to the correct “Shore hardness” 40a of the silicone of the edge region and the resulting elasticity of the material.

The LED module is equipped with a powerful rechargeable battery and has a total diameter of preferably 60 to 70 mm, in particular 65 mm, and a height of 5 to 15 mm, preferably 8 mm.

By way of example, 3 dimming functions can be set via the ON/OFF button in the base: 25%, 50% and 100%. The battery life at full light intensity should be more than 12 hours.

Studies have shown that the preferably warm-white light emitted by LED chips having light values of 2600-2800 Kelvin has a particularly calming and at the same time relaxing effect and stimulates the production of serotonin, which has a positive effect on gastrointestinal balance and regulates blood pressure.

By virtue of this invention, the child can in future find his bottle in the dark by himself.

The LED module is rechargeable.

The solution according to the invention makes drinking easy, replaces the night light that is commonly used, and makes drinking using the child's bottle a fun and yet calming experience.

It is wonderful to look at, and the refracted light makes the child appear in a special light.

The child will probably want to drink more due to the fact that the drinking bottle is always visible.

The use of commercially available night lights for your child has become superfluous as a result of our product.

Due to the latest LED technology and rechargeable lithium-ion batteries, the product is state-of-the-art. The powerful battery in this small structural form gives a very long illumination time of more than 12 hours, at full light intensity. The cover, which contains the LED module, is made of food-safe silicone. It makes a nice accessory for your baby/toddler bottles.

The name of the product “Bumpli” has already been registered as a trademark.

The new type of silicone protector gives off light at night, which provides orientation, and if the bottle falls it provides effective protection against impact, which prevents the bottle from breaking.

The silicone protector is not only suitable for baby and toddler bottles, but also for athletes, for example cyclists, walkers, climbers, and other groups of people who need to see the position of the bottle in the dark when necessary.

This is also particularly important for older people who have placed their glass, a mug or a bottle for example next to their bed on a table or other storage space in order to have a drink at night. Due to the fact that the vessel is now illuminated, the position of the vessel can be seen even when it is otherwise dark in the room, and it can be safely picked up and put down again. This prevents the glass or bottle from falling. In addition, the “grip” when taking hold of the vessel is better with the silicone protector, which is likewise advantageous for older people.

1. Silicone protector (1) for a drinking vessel (7), the silicone protector having a circumferential edge region (3) with a top opening (1.1) for a region of the drinking vessel (7) that protrudes out of the top opening (1.1), and having a base region, characterized in that the silicone protector (1) has an LED module (2), in that the LED module (2) is disc-shaped and is inserted into the silicone protector (1) above the base region (3.2), and in that the edge region (3) made of silicone is so elastic that it can be widened from an internal diameter that is smaller than the external diameter of the LED module (2) and the external diameter of the drinking vessel (7) to a diameter that makes it possible to receive the LED module (2) and that is larger than the external diameter of the drinking vessel (7).

2. Silicone protector according to claim 1, characterized in that the edge region (3) is circumferentially closed and encircles the LED module (2).

3. Silicone protector according to claim 1, characterized in that the silicone protector (1) has a base region (3.2) which adjoins the edge region (3) opposite the top opening (1.1), and in that the edge region (3) and/or the base region (3.2) is detachably or non-detachably connected to the LED module (2).

4. Silicone protector according to claim 1, characterized in that the LED module (2) has an on/off switch (5) on its underside (2b) pointing in the direction of the base region (3.2).

5. Silicone protector according to claim 1, characterized in that the base region (3.2) has a bottom opening (9) in the region of the on/off switch (5).

6. Silicone protector according to claim 1, characterized
in that the edge region (3) has a circumferential region (3.1) which first in a first sub-region (3.1a) is substantially cylindrical and has an internal diameter (D1),
in that a second sub-region (3.1b), which adjoins the first sub-region (3.1a) in the upward direction, reduces from the internal diameter (D1) to an internal diameter (D2) in the region of the top opening (1.1),
in that the first sub-region (3.1a) is adjoined at the bottom by the base region (3.2), and
in that the first sub-region (3.1a) at least partially encloses the LED module (2) around the circumference, and the base region (3.2) at least partially encloses the LED module (2) on the underside (2b).

7. Silicone protector according to claim 1, characterized in that the first sub-region (3.1a) has an aperture (8) in the region of a connection socket (4) of the LED module (2).

8. Silicone protector according to claim 1, characterized in that the LED module (2) has at least one illuminating element, in particular an LED (2.2), on its circumference and/or on its upper side (2a) pointing in the direction of the top opening (1.1), and in that the LED module (2) is transparent at least in the region of the illuminating element(s) (2.2).
